(19) United States
(12) Patent Application Publication
(10) Pub. No.: US 2018/0074675 A1
(43) Pub. Date: Mar. 15, 2018

(54) DISPLAY DEVICE AND CONTROL METHOD THEREOF

(71) Applicant: SAMSUNG ELECTRONICS CO., LTD., Suwon-si (KR)

(72) Inventors: Byung Seok SOH, Yongin-si (KR); Chang Won SON, Seoul (KR); Ho June YOO, Seoul (KR); Kyung-Hoon LEE, Seoul (KR)

(73) Assignee: SAMSUNG ELECTRONICS CO., LTD., Suwon-si (KR)

(21) Appl. No.: 15/671,286

(22) Filed: Aug. 8, 2017

(30) Foreign Application Priority Data
Sep. 12, 2016 (KR) 10-2016-0117468

(51) Int. Cl. G06F 3/0488; G06F 3/043; G06F 3/14

(52) U.S. Cl. CPC G06F 3/0488; G06F 3/043; G09G 3/2003; G08C 2201/42; G06F 3/1423

(57) ABSTRACT

A display device including a display panel having a variable curvature, the variable curvature being configured to switch between a curved state and a flat state, a frame configured to fix a portion of the display panel, a sensor mounted on the frame, the sensor being configured to transmit and receive acoustic waves, and a controller configured to determine whether an object is in contact with the frame based on a signal associated with the acoustic waves, wherein, while the variable curvature is switching from the curved state to the flat state, the switching is stopped in response to a determination that the object is in contact with the frame.

### CROSS-REFERENCE TO RELATED APPLICATION

This application claims the benefit of Korean Patent Application No. 10-2016-0117468, filed on Sep. 12, 2016 in the Korean Intellectual Property Office, the disclosure of which is incorporated herein by reference.

### BACKGROUND

### 1. Technical Field

Exemplary embodiments of the present disclosure relate to a display device and a control method thereof capable of adjusting a curvature of a display panel.

### 2. Description of Related Art

In general, a flat display device in which a display panel is fixed in a flat state or a curved display device in which a display panel is fixed in a curved state has been common.

However, depending on the user's tendency or the displayed content, the flat display panel may be optimal or the curved display panel may be optimal. Therefore, recently, a curvature variable display device capable of changing the curvature of the display panel interchangeable in a flat state and in a curved state has been developed. A curvature-variable display device is also referred to as a bendable display device.

### SUMMARY

Therefore, exemplary embodiments of the present disclosure provide a display device and a control method when a display panel switches from a curved state to a flat state, it senses that a body part, such as a user's hand, or other object is positioned between the display panel and the frame support, and it performs appropriate control to prevent an accident or damage to a device.

According to an aspect of an exemplary embodiment, a display device includes a display panel having a variable curvature, the variable curvature being configured to switch between a curved state and a flat state, a frame configured to fix a portion of the display panel, a sensor mounted on the frame, the sensor being configured to transmit and receive acoustic waves, and a controller configured to determine whether an object is in contact with the frame based on a signal associated with the acoustic waves, wherein, while the variable curvature is switching from the curved state to the flat state, the switching is stopped in response to a determination that the object is in contact with the frame.

The controller may be further configured to determine that the object is in contact with the frame when an amplitude of the signal associated with the acoustic waves is less than a predetermined threshold value.

The controller may be further configured to set the predetermined threshold value based on the variable curvature of the display panel.

The controller may be further configured to decrease the predetermined threshold value as the variable curvature of the display panel decreases.

The sensor may include a plurality of transmitters configured to transmit the acoustic waves, and a plurality of receivers configured to receive the acoustic waves propagated through a surface of the frame.

The plurality of transmitters may be further configured to sequentially transmit the acoustic waves.

The plurality of transmitters may be further configured to transmit the acoustic waves in a more adjacent order as a plurality of distances between the plurality of transmitters increase.

The controller may be further configured to determine whether the object is in contact with the frame based on a predetermined threshold value, and the controller may be further configured to set the predetermined threshold value based on a distance between the plurality of transmitters and the plurality of receivers.

At least one of the plurality of receivers may be mounted in an area adjacent to the fixed portion of the display panel.

The sensor may be activated when the switching begins.

The controller may be further configured to stop the switching and to return the display panel to the curved state when it is determined that the object is in contact with the frame during the switching of the display panel from the curved state to the flat state.

The controller may be further configured to set the predetermined threshold value based on a size of the display panel.

According to an aspect of an exemplary embodiment, a control method of a display device with a display panel with a variable curvature, the display device including a frame, includes transmitting acoustic waves using a transmitter mounted on the frame, receiving the acoustic waves using a receiver mounted on the frame, determining whether an object is in contact with the frame based on a signal associated with the acoustic waves received using the receiver, and while the variable curvature of the display panel is switching from a curved state to a flat state, stopping the switching in response to a determination that the object is in contact with the frame.

The method may further include determining that the object is in contact with the frame when an amplitude of the signal associated with the acoustic waves is less than a predetermined threshold value.

The predetermined threshold value may be set based on the variable curvature of the display panel.

The predetermined threshold value may be decreased when the variable curvature of the display panel decreases.

The transmitter may include a plurality of transmitters, and the receiver comprises a plurality of receivers.

The transmitting of the acoustic waves may include transmitting the acoustic waves sequentially from the plurality of transmitters.

The transmitting of the acoustic waves may include transmitting the acoustic waves in a more adjacent order as a plurality of distances between the plurality of transmitters increase.

The determining of whether the object is in contact with the frame may include setting the predetermined threshold value based on a distance between the plurality of the transmitters and the plurality of the receivers.

### BRIEF DESCRIPTION OF THE DRAWINGS

These and/or other aspects of the disclosure will become apparent and more readily appreciated from the following description of the exemplary embodiments, taken in conjunction with the accompanying drawings of which:

FIG. 1 and FIG. 2 are illustrating an appearance of a display device in accordance with exemplary embodiments of the present disclosure.

FIG. 3 is a drawing illustrating a hand-pitching phenomenon that may occur during an unbending operation of the display device.

FIG. 4 is a control block diagram illustrating a display device in accordance with one exemplary embodiment of the present disclosure.

FIG. 5 is a drawing illustrating a structure of a display panel including a light emitting diode.

FIG. 6 is a drawing illustrating a structure of a display panel including an organic light emitting diode.

FIG. 7 is a control block diagram illustrating a sensing unit.

FIG. 8 and FIG. 9 are drawings illustrating an example of a sensing unit that senses contact using an acoustic wave signal in accordance with one exemplary embodiment of the present disclosure.

FIG. 10 is a drawing illustrating an example of the arrangement of a transmitter and a receiver in a display device in accordance with one exemplary embodiment of the present disclosure.

FIG. 11 is a drawing illustrating an example of a procedure in which a transmitter generates acoustic waves.

FIG. 12 is a drawing illustrating spectra respectively obtained in a flat state and a curved state of the display panel.

FIG. 13 is a drawing illustrating a state of change of the display panel during an unbending operation.

FIG. 14 is a graph for explaining an operation of analyzing an acoustic wave signal based on a variable threshold value.

FIG. 15 and FIG. 16 are drawings illustrating an example of the arrangement of a control unit in the display device in accordance with one exemplary embodiment of the present disclosure.

FIG. 17 is a flowchart illustrating a method of controlling a display device in accordance with one exemplary embodiment of the present disclosure.

FIG. 18 is a flowchart illustrating a step of detecting a touch of a hand in a method of controlling a display device specifically in accordance with one exemplary embodiment of the present disclosure.

### DETAILED DESCRIPTION

Hereinafter, exemplary embodiments of the present disclosure will be described in detail.

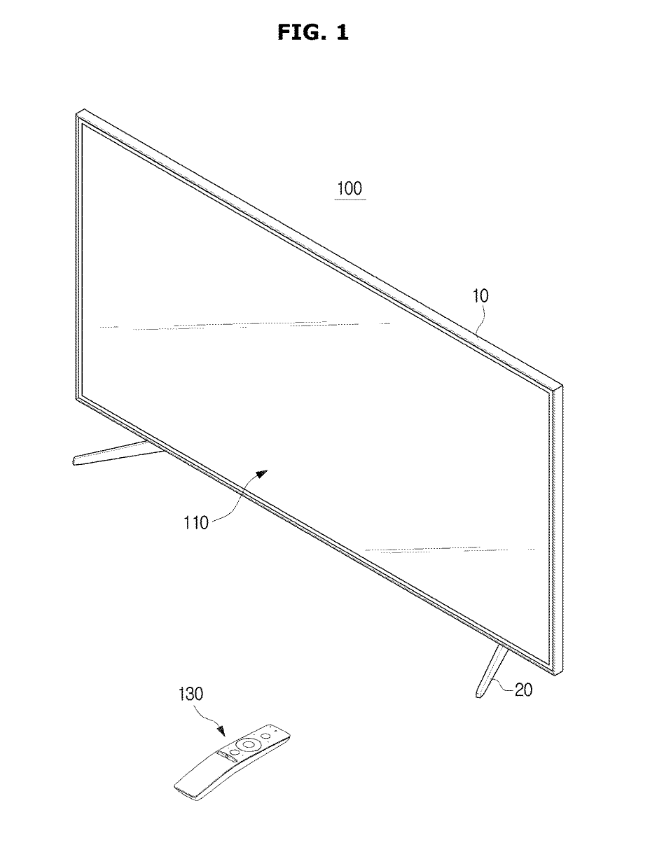

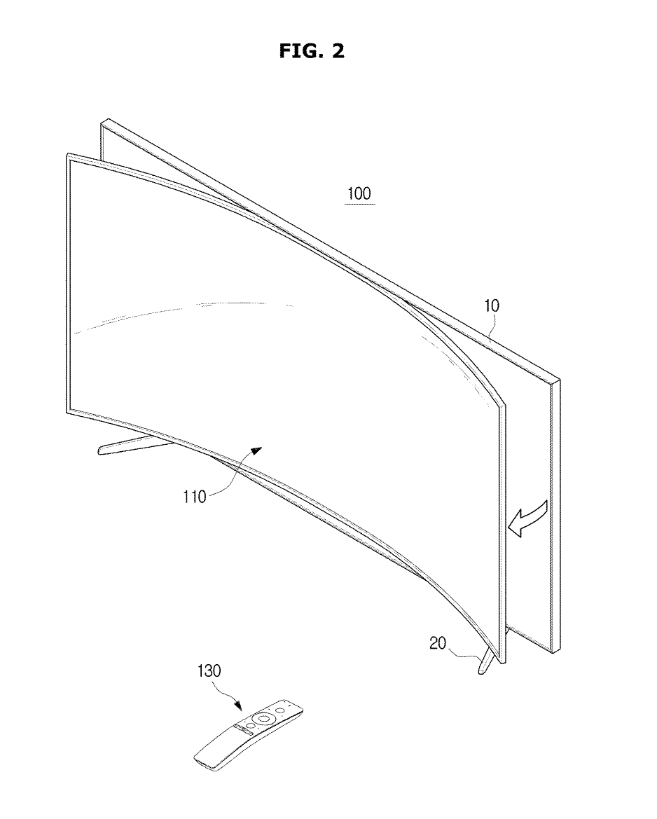

FIG. 1 and FIG. 2 are showing an appearance of a display device in accordance with an exemplary embodiment of the present disclosure.

A display device 100 in accordance with one exemplary embodiment refers to a device capable of processing an image signal stored in advance or received from the outside and outputting an image. For example, when the display device 100 is a TV, a broadcasting signal received from a broadcasting station is received and processed to output an image with sound included in the broadcasting signal. Alternatively, it is possible to receive a video signal and an audio signal from a set-top box.

In the following exemplary embodiment, the case in which the display device 100 is a TV will be described as an example. However, the exemplary embodiment of the display device 100 is not limited to a TV, and the name and the type of the display device 100 are not limited as long as it includes a display panel for displaying an image.

Referring to FIG. 1 and FIG. 2, the display device 100 includes a display panel 110 for displaying an image and a frame 10 disposed behind the display panel 110 to support the display panel 110.

Also, as in the example of FIG. 1 and FIG. 2, when the display device 100 is implemented as a stand type, a stand 20 supporting the display device 100 which may be stably placed on a horizontal plane is disposed at the lower end of the frame 10.

In addition, when the display device 100 is implemented as a wall-mounted type, a structure such as a bracket may be provided on the rear surface of the frame 10 to install the display device 100 on a wall.

The display panel 110 may be in a flat state as shown in FIG. 1, and the display panel 110 may have both left and right ends to be protruded when the display panel is in curved state by bending with a certain curvature as shown in FIG. 2. The display device 100 in accordance with one exemplary embodiment is implemented as a bendable display device capable of switching between a flat state and a curved state. Also, the display device may be referred to as a flexible display device, if the display device can be switched between a flat state and a curved state regardless of the name.

In this exemplary embodiment, an operation of switching from a flat state to a curved state is referred to as a bending operation, and an operation of switching from a curved state to a flat state is referred to as an unbending operation. However, the bending and unbending are only the names used for convenience of explanation, and the operation of switching between the flat state and the curved state regardless of the names of the operation is included in the scope of the present disclosure.

For example, a button for receiving a selection command of the flat state and the curved state of the display panel 110 from the user may be provided. These buttons may be provided on a remote controller 130 capable of remotely controlling the display device 100 or may be provided in one area of the display panel 110 or one area of the frame 10.

In addition, when one of the flat state and the curved state is set to the default state, the flat state or the curved state can be brought into a flat state or a curved state when the display device 100 is powered on. For example, when the curved state is set to a default state and the display device 100 is powered on, the display panel 110 is bent to switch from a flat state to a curved state. Also, when the power is turned off, the display panel 110 may be unbent to switch from a curved state to a flat state.

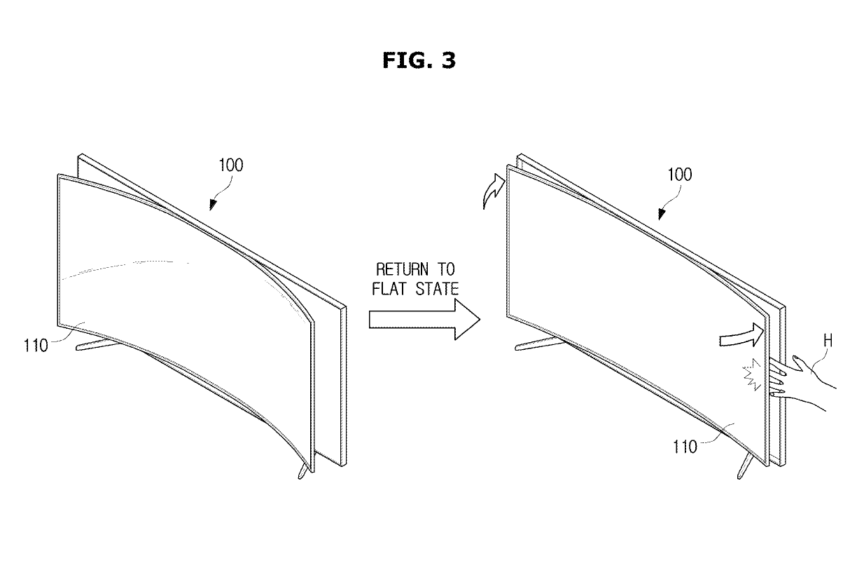

FIG. 3 is a drawing illustrating a hand-pitching phenomenon that may occur during an unbending operation of the display device.

As shown in FIG. 3, a user's hand H may be caught between the display panel 110 and the frame 10 while the display panel 110 is unbending and is being switched from the curved state to the flat state.

Because the interval between the display panel 110 and the frame 10 in the flat state is very small, if the unbending operation is continued without stopping the unbending operation when the user's hands H are stuck, there is a danger of an accident, and the display device may be damaged or broken.

Therefore, the display device 100 with the exemplary embodiment detects that the hand is positioned between the display panel 100 and the frame 10 when the unbending operation is being performed. Then, the display device 100 stops the unbending operation or performs the bending operation again when a hand is detected to prevent the risk of accidents due to the hand-pinched phenomenon and the breakage of the device.

In addition, it is possible to prevent the hand-pinched phenomenon by sensing when the user's hand touches the display device before the hand is caught, rather than detecting the hand-pinched phenomenon.

An exemplary embodiment of the present disclosure will be described with an explanation of an example in which the touch of a user's hand is detected. However, the exemplary embodiment of the display device 100 is not limited thereto, and may detect the contact of other body parts other than the hand, or may detect the contact of other objects other than the body parts.

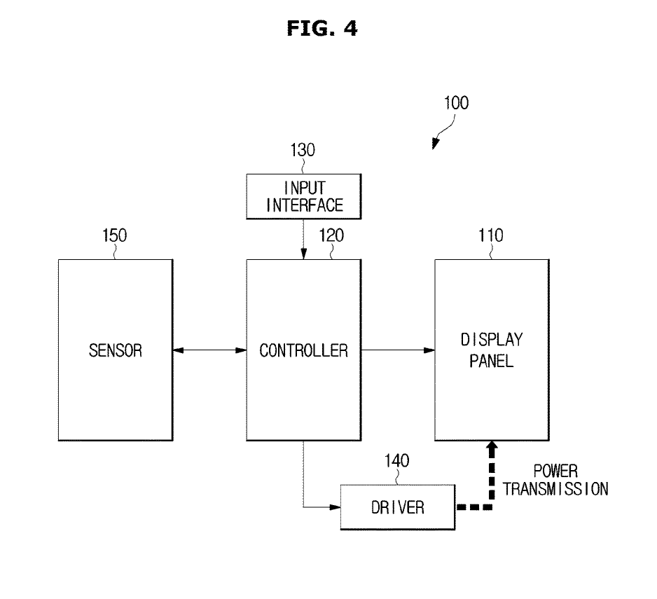

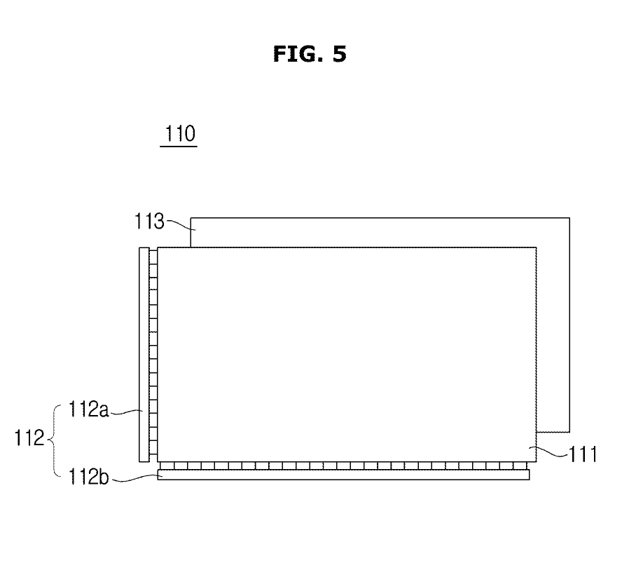

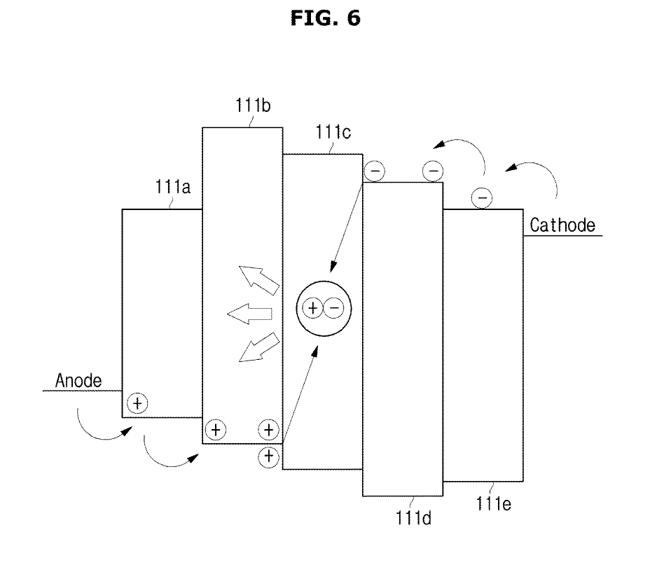

FIG. 4 is a control block diagram illustrating a display device in accordance with one exemplary embodiment of the present disclosure, FIG. 5 is a drawing illustrating a structure of a display panel including a light emitting diode, and FIG. 6 is a drawing illustrating a structure of a display panel including an organic light emitting diode.

Referring to FIG. 4, a display device 100 includes a display panel 110 capable of changing its curvature and capable of switching between a flat state and a curved state, a driver 140 providing a deformation force to deform the curvature of the display panel 110. An input interface 130 for receiving a selection of a curved state, a sensor 150 for sensing the touch of a user's hand or other objects, a controller 120 for controlling the bending/unbending operation of the display panel 110 according to the detection result of the sensor 150.

The display panel 110 may be implemented as a liquid crystal display LCD panel, a light emitting diode LED panel, or an organic light emitting diode OLED panel. Any panel outputting an image and switching the curvature can be the display panel 110.

For example, when the display panel 110 is implemented as an LED panel, the display panel 110 may include a displayer 111, a panel driver 112, and a back-lighter 113, as shown in FIG. 5.

The displayer 111 can display image information such as characters, numbers, and graphics by adjusting the transmittance of light passing through the liquid crystal layer, and the transmittance of light passing through the liquid crystal layer can be adjusted according to the intensity of the applied voltage.

The displayer 111 may include a color filter panel, a thin film transistor array panel (TFT), a liquid crystal layer, and a sealant.

The color filter panel may include red, green, and blue color filters formed in a region corresponding to the pixel electrode of the TFT panel so that the color can be displayed for each pixel. Also, a color filter panel may be formed of a transparent conductive material such as Indium Tin Oxide (ITO) or Indium Zinc Oxide (IZO).

The TFT panel of the displayer 111 may be spaced apart from the color filter panel and may include a plurality of gate lines, a date line, and a pixel electrode.

Here, the gate lines are arranged in the row direction to transmit the gate signals, the data lines are arranged in the column direction to transmit the data signals, and the pixel electrodes are connected to the gate lines and the data lines, and may include the switching elements and the capacitors.

The switching elements are formed at the intersection of the gate line and the data line, and a capacitor may be connected to an output terminal of the switching element. The other terminal of the capacitor may be connected to a common voltage or to a gate line.

The liquid crystal layer included in the displayer 111 is disposed between the color filter panel and the TFT panel, and includes a sealing material and a liquid crystal contained in the sealing material. The alignment direction of the liquid crystal layer is changed by a voltage applied from the outside. At this time, the transmittance of light passing through the liquid crystal layer is controlled.

On the other hand, a color filter panel, a TFT panel and a liquid crystal layer of the displayer 111 are constituted with a liquid crystal capacitor, and the liquid crystal capacitor, and the displayer 111 is connected to a common voltage or a reference voltage with the output terminal of the switching element of the pixel electrode.

The panel driver 112 may include a gate driver 112a for generating a gate pulse to supply the gate pulse to the gate line and a data driver 112b for generating a data voltage to supply the gate pulse to the data line.

The data driver 112b selects the gradation voltage for each data line based on the image data, and transmits the selected gradation voltage to the liquid crystal through the data line.

The gate driver 112a transmits an ON or OFF signal based on the image data to the thin film transistor through the scan line to turn on or turn off the thin film transistor.

When the voltage corresponding to each color value is supplied from the data driver 112b, the gate driver 112a receives the voltage and opens the voltage to the corresponding pixel.

A source electrode of the TFT Panel is connected to the data line, a gate electrode is connected to the gate line, and a drain electrode of the TFT panel is connected to the pixel electrode of Indium Tin Oxide (ITO). Such TFT panel is turned on when a scanning signal is supplied to the scan line and supplies a data signal supplied from the data line to the pixel electrode.

A predetermined voltage is supplied to the common electrode, and an electric field is formed between the common electrode and the pixel electrode. Such an electric field changes the arrangement angle of the liquid crystal between the liquid crystal panels, and changes the light transmittance according to the changed arrangement angle to display a desired image.

A desired image can be implemented on the displayer 111 by supplying the gate drive signal and the data drive signal based on the gate control signal, the data control signal and the related data signal to the gate line and the data line formed on the TFT panel from the panel driver 112, respectively.

The back-lighter 113 includes a direct type in which a light source is arranged on a lower surface of the displayer 111 to emit light and an edge type in which a light guide plate is provided below the displayer 111 with a light source provided at the edge of the light guide plate which emits light.

As another example, when the display panel 110 is implemented as an OLED panel, it is not necessary to provide a backlight unit by disposing an OLED, which is a self-luminous element, in a pixel region formed by crossing the gate line and the data line.

An OLED disposed in each pixel constituting the displayer 111 of the display panel 110 includes an organic compound layer which can be stacked between an anode and a cathode, such as a hole injection layer 111a, a hole transport layer 111b, an emission layer 111c, an electron transport layer 111d and an electron injection layer 111e

The input image can be reproduced by using a phenomenon in which a current flows through a fluorescent or phosphorescent organic thin film, and light is emitted when electrons and holes in the organic light emitting diode disposed in each pixel are coupled in an organic layer.

When the display panel 110 is implemented as an OLED panel, the display panel 110 can be variously classified according to a type of light emitting material, a light emitting method, a light emitting structure, a driving method, and the like. It can be classified into fluorescent light emission and phosphorescent light emission according to the light emission method, and can be classified into a top emission structure and a bottom emission structure depending on the light emitting structure. Also, according to the driving method, it can be classified into a passive matrix OLED and an active matrix OLED.

The structure of the above-described display panel 110 is only an example that can be applied to the present disclosure, and other structures other than the above structure may be applied.

Meanwhile, the display panel 110 may be flat. When the external force is not applied, the display panel 110 is in a flat state, and when an external force is applied to both the left and right ends of the display panel 110 from a driver 160, it can be bent and become a curved state.

The driver 160 includes a motor that is installed on the front surface of the frame 10 to generate power to be transmitted to both the left and right ends of the display panel 110 and a mechanical structure for transmitting the generated power to both the left and right ends of the display panel 110. For example, the mechanical structures may include a pinion that rotates together with the rotation of the motor, a rack that is engaged with the pinion and moves toward the display panel 110 in accordance with the rotation of the pinion, a rack, a moving member, a rotating member, or the like, which pushes the left and right ends of the display panel 110 to the front side.

As described above, when a bending command is input through the input interface 130, the driver 160 generates an external force required for curvature transformation of the display panel 110 to bend the display panel 110, and when an unbending command is input, the display panel 110 can be returned to the flat state by removing the external force.

In addition to the bending/unbending commands, the input interface 130 may include buttons for receiving various commands related to the control of the display device 100 such as channel selection, power ON/OFF, screen adjustment, and external input selection.

The input interface 130 may include a plurality of buttons corresponding to the respective control commands. The plurality of buttons may be implemented as a push button, a touch button, or the like, as long as they can receive bending/unbending commands. There is no limitation on the types of buttons constituting the input interface 130.

As described above, when the user's hand is positioned between the display panel 110 and the frame 10 during the unbending operation in which the display panel 110 is switched from the curved state to the flat state, an accident may occur. Therefore, the sensor 150 senses whether the user's hand touches the frame 10, and if the user's hand contacts the frame 10, the controller 120 may stop the unbending operation or perform the bending operation again.

Hereinafter, the configuration of the sensor 150 for detecting whether the user's hand is in contact will be described in detail.

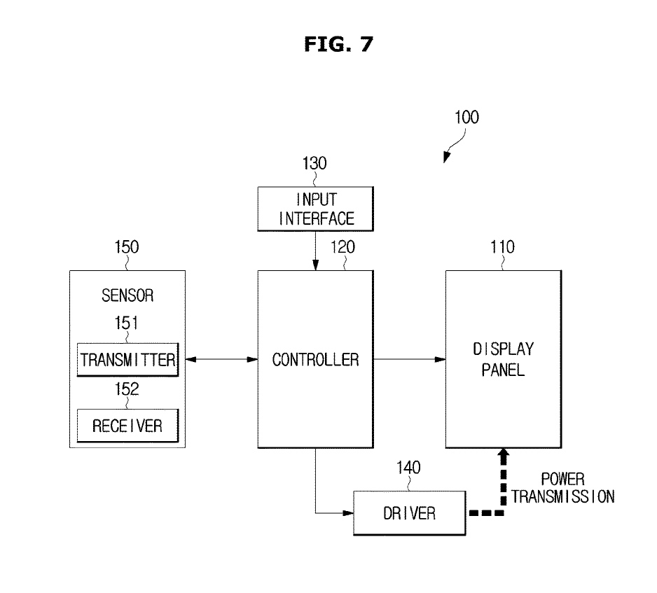

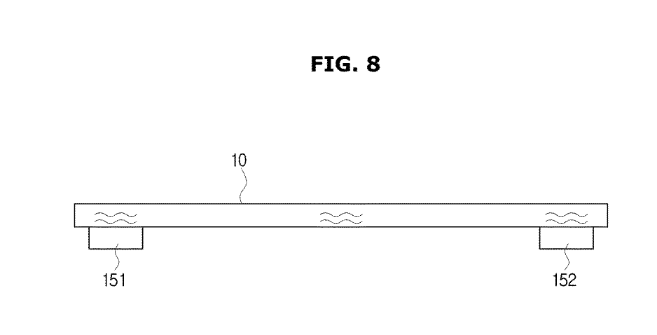

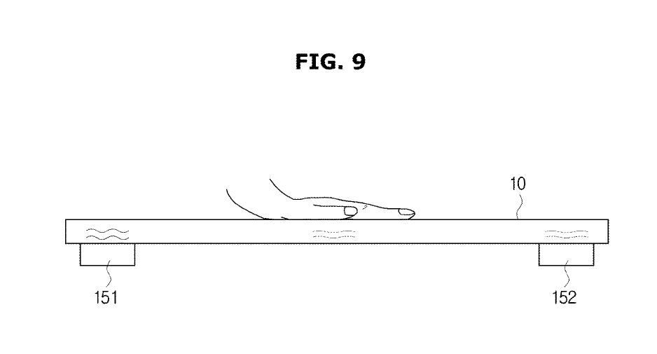

FIG. 7 is a control block diagram illustrating a sensor in specific, and FIG. 8 and FIG. 9 are drawings illustrating an example of a sensing unit that senses contact using an acoustic wave signal in accordance with one exemplary embodiment of the present disclosure.

Referring to FIG. 7, the sensor 150 includes a transmitter 151 for transmitting a signal and a receiver 152 for receiving a transmitted signal. The intensity of a signal received by the receiver 152 varies when the user's hand touches a frame 10 and when the user's hands touch the frame 10, the controller 120 may analyze the signal received by the receiver 152 to determine whether or not it is in contact.

For example, the sensor 150 may include a transmitter for transmitting a signal of acoustic wave and the receiver 152 for receiving a signal of sound wave.

The transmitter 151 can generate an acoustic wave using a piezoelectric element, and the receiver 152 can sense an acoustic wave using an electromagnetic or piezoelectric microphone, a ceramic sensor, a piezoelectric element, or the like.

FIG. 8 and FIG. 9 are side vies of the frame 10 when viewed from the side in a state in which the front surface of the frame 10 is laid down.

Referring to FIG. 8, when the transmitter 151 mounted on the frame 10 generate acoustic waves, the generated acoustic waves propagate along the surface of the frame 10. Thus, the propagation of sound waves along the surface of a solid or liquid is called Surface Acoustic Wave (SAW)

The receiver 152 can be mounted on the frame 10 away from the transmitter 151 and receives the acoustic waves propagated along the surface of the frame 10. The receiver 152 converts the received acoustic wave into an electrical signal; in the exemplary embodiments described later, this electrical signal is referred to as an acoustic wave signal. The acoustic wave signal is transmitted to the controller 120.

The transmitter 151 and the receiver 152 are mounted on the rear surface of the frame 10 as an example but the transmitter 151 and the receiver 152 may be mounted on the frame 10 in accordance with the mechanical configuration of the display device 100, or may be mounted on the front surface of the frame 10.

If the speed or amplitude of the acoustic wave changes due to a change in the physical characteristics of the acoustic wave along the surface, the acoustic wave signal received by the receiver 152 has a different frequency or amplitude from the acoustic wave signal generated by the transmitter 151.

Referring to FIG. 9, when the user's hand H touches the frame 10, the amplitude of the sound wave propagating along the surface of the frame 10 is changed. Specifically, when the user's hand H touches the frame 10, the wave is attenuated and the amplitude of the acoustic wave becomes small.

In some cases, it is also possible that the frequency of an acoustic wave changes or the amplitude increases. For example, if the user holds the frame 10 and shakes it, it is possible that the frequency of the acoustic wave changes or the amplitude increases. The following description will be made on the assumption that the user's hand H only touches the frame.

As described above, the characteristics of the acoustic wave signal received by the receiver 152 vary depending on whether the user's hand H is in contact with the frame 10, so that the controller 120 can analyze the acoustic wave signal and determine whether there is hand contact or not.

The controller 120 may include a memory for storing a program for performing the above-described operation and an operation to be described later, and a processor for executing the stored program. The memory and the processor may be implemented as a single chip or as separate chips. Also, the memory and the processor may have a plurality of elements integrated or physically separate.

In addition, the controller 120 may control the overall operation of the display device 100 in addition to determining hand contact by analyzing the signal transmitted from the sensor 150. Also, the processor and the memory for other controls than the judgment of the hand contact may be separately provided. Concrete operations performed by the controller 120 will be described later.

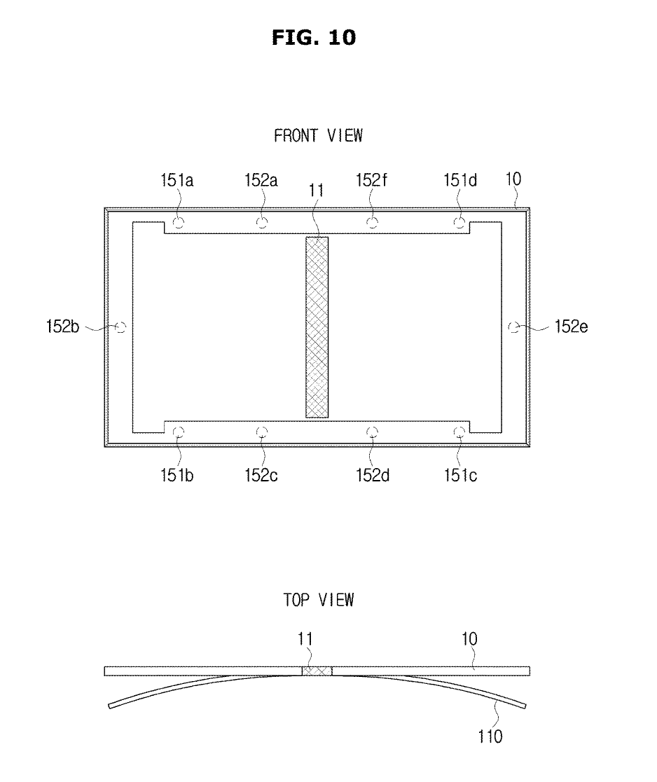

FIG. 10 is a drawing illustrating an example of an arrangement of a transmitter and a receiver in a display device in accordance with one exemplary embodiment of the present disclosure.

Referring to FIG. 10, when the frame 10 is viewed from the front view, a fixing part 11 to which the display panel 110 is fixed is provided at the center of the frame 10.

Looking down on the frame 10, the central portion of the display panel 110 is fixed to the frame 10 through the fixing part 11, the remaining portions except for the fixed central portion are provided in a non-fixed state from the frame 10, so that the left and right ends of the display panel 110 can be bent away from the frame 10.

The transmitter 151 and the receiver 152 may be disposed in consideration of positions where interference may occur, and may be provided with a plurality of elements, respectively. For example, when the transmitter 151 and the receiver 152 are disposed adjacent to the edge of the frame 10, respectively, it is possible to detect the contact of the user's hand H effectively when the structures such as the driver 160 are mounted on the center of the frame 10.

The transmitter 151 may be disposed between the plurality of receivers 152 and the number of the receivers 152 may be provided in a large number.

In consideration of the coverage of the transmitter 151 and the receiver 152, it is possible to arrange them in a number that covers all directions.

For example, as referring to FIG. 10, a first transmitter 151a, a second transmitter 151b, a third transmitter 151c and a fourth transmitter 151d may be disposed in the edge region of the frame 10, and a first receiver 152a, a second receiver 152b, a third receiver 152c, a fourth receiver 152d, a fifth receiver 152e and a sixth receiver 152f may be disposed in the area adjacent to the transmitter 151.

According to the arrangement in FIG. 10, the first transmitter 151a is located between the first receiver 152a and the second receiver 152b and the second transmitter 151b is located between the second receiver 152b and the third receiver 152c. Also, the third transmitter 151c is located between the fourth receiver 152d and the fifth receiver 152e and the fourth transmitter 152d is located between the fifth receiver 152e and the sixth receiver 152f. Because the first receiver 152a, the third receiver 152c, the fourth receiver 152d and the sixth receiver 152f are disposed adjacent to the fixing part 11, a blind area can be minimized.

The arrangement in FIG. 10 is merely an example, and it is possible that the sensor 150 may be disposed in a region near the center depending on the position of other structures mounted on the frame 10.

In addition, when the display device 100 is implemented as a stand type, it is also possible to arrange more transmitters 151 and receivers 152 on the sides of the frame 10 than on the top or bottom. In this case, the transmitter 151 disposed on the side can control the transmission of the acoustic wave first.

Further, when the display device 100 is implemented as a wall-mounted type, it is also possible to arrange more transmitters 151 and receivers 152 on the bottom of the frame 10 than on the top of the frame. In this case, the transmitter 151 disposed on the bottom can control the transmission of acoustic wave first.

As described above, when the sensor 150 is implemented as a transmitter and a receiver for transmitting and receiving acoustic waves, it is possible to detect the contact without applying a large physical pressure, and it is possible to cover almost the whole area without a blind area even if it is not arranged densely as compared with other sensors, so that the arrangement of other structures provided in the display device 100 is not affected and the cost can be reduced. Further, because the display device 100 does not protrude to the outside, the appearance of the display device 100 is not damaged.

Meanwhile, the sensor 150 may be turned on only when the power of the display device 100 is turned on, or may be turned on only during the bending/unbending operation, or may be turned on only during the unbending operation.

In other words, the sensor 150 may be turned on when the power-on command of the display device 100 is input, and may be turned off when the power-off command of the display device 100 is input. Alternatively, it may be turned on when the bending/unbending command is input, and turned off when the bending/unbending operation is completed. Also, it may be turned on when the unbending command is input, and turned off when the unbending operation is completed. It is also possible to physically sense the unbending operation of the display panel 110. For example, it is possible to determine whether the unbending operation is being performed based on a signal output from a sensor provided in the motor of the driver 160 or a sensor capable of detecting the position of the display panel 110.

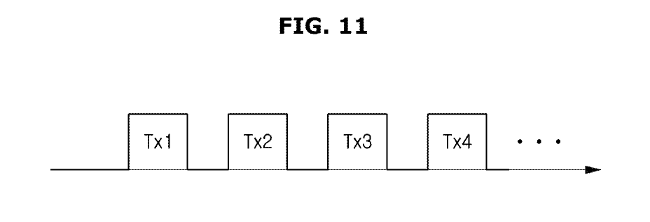

FIG. 11 is a drawing illustrating an example of a procedure in which a transmitter generates acoustic waves.

As shown in FIG. 11, the plurality of transmitters 151 sequentially generates acoustic waves, thereby preventing interference due to acoustic waves generated in other transmitters. In this example, an acoustic wave Tx1 generated in the first transmitter 151a, an acoustic wave Tx2 generated in the second transmitter 151b, an acoustic wave Tx3 generated in the third transmitter 151c, and an acoustic wave Tx4 generated in the fourth transmitter 151d transmit the acoustic wave sequentially, however, the present disclosure is not limited thereto.

For example, in order to minimize the interference between the transmitted signals, the transmitter spaced apart from each other may transmit signals in an adjacent order.

According to the arrangement in FIG. 10, the third transmitter 151c transmits acoustic waves after the first transmitter 151a transmits the acoustic waves, and then the second transmitter 151b and the fourth transmitter 151d transmit acoustic waves.

The receiver 152 may amplify the acoustic wave signal and transmit the amplified acoustic wave signal to the controller 120. The controller 120 may include an analog-to-digital converter (ADC) to convert the analog acoustic wave signal into a digital acoustic wave signal.

The controller 120 may perform the following frequency analysis on each of the acoustic wave signals transmitted from the plurality of receivers 152a, 152b, 152c, 152d, 152e, and 152f to determine whether or not the hand is in contact. Also, it is possible to select the receiver 152 to perform the frequency analysis in consideration of the transmission order and the transmission timing of the transmitter 151. For example, in the arrangement in FIG. 10, when the first transmitter 151a or the second transmitter 151b transmits an acoustic wave, the acoustic wave signal of the fifth receiver 152e may be excluded from the frequency analysis.

In this way, the transmitter 151 transmitting the acoustic wave at the time of analysis and the receiver 152 far away from the receiver can be excluded from the frequency analysis target, thereby reducing the calculation amount of the controller 120 and obtaining results faster. For this purpose, the controller 120 may set or store the receiver 152, which is a frequency analysis object, at the time of an acoustic wave transmission of the corresponding transmitter 151 to each of the plurality of transmitters 151 in advance.

The controller 120 may store the change pattern of the acoustic wave signal in advance. Specifically, comparing the received acoustic wave signal pattern between when a hand touches and when the hand does not touch, a threshold value may be set as a criterion for judging whether to make a determination of touch can be set in advance. The threshold value may be set by experiment, simulation, and the like, and it is also possible that the display device 100 is provided with a calibration mode so that the threshold value is reset by the user or a repairman even after the manufacturing is completed.

In setting and applying the threshold value, the acoustic wave transmission order, transmission timing, and reception timing of the transmitter 151 can be considered. For example, the thresholds can be set differently for each of the plurality of receivers 152 through experiments or simulations, and the threshold value can be set differently for the same receiver 152 according to the position of the transmitter 151 that generates acoustic waves. A small threshold value may be applied to the transmitter 151 which is distant from the receiver 152 and a large threshold value may be applied to the transmitter 151 which is close to the receiver 152.

Specifically, in the case that a first threshold value for the case where the first transmitter 151a transmits acoustic waves, a second threshold value for the case where the second transmitter 151b transmits acoustic waves, a third threshold value for the case where the third transmitter 151c transmits acoustic waves, and a fourth threshold value for the case where the fourth transmitter 151d transmits the acoustic wave, it is possible to apply a threshold value corresponding to the transmission order of the plurality of transmitters during the actual unbending operation.

Meanwhile, the sensor 150 can generate an acoustic wave having a specific frequency, and the frequency can be selected in a band free from confusion with a frequency generated by the display device 100. Therefore, the receiver 152 can sense the vibration in the state where the display device 100 is moving and the state where there is no movement, and can select the frequency having the largest response value among the frequencies distinguished from the frequency band of the sensed vibration.

For example, the controller 120 applies a band-pass filter (BPF) to an acoustic wave signal to remove a noise signal outside the selected frequency, applies envelope detection to the noise signal to make it possible to perform signal processing. It is possible to determine whether or not the hand is in contact by comparing the acoustic wave signal subjected to the signal processing with a preset threshold value.

As described above, because the wave is attenuated by the contact of the hand, it can be judged that the hand is in contact when the acoustic wave signal is less than the predetermined threshold value.

In addition, the controller 120 may determine that the hand is in contact when at least one of the acoustic signals transmitted from the plurality of receivers 152 is less than a preset threshold value.

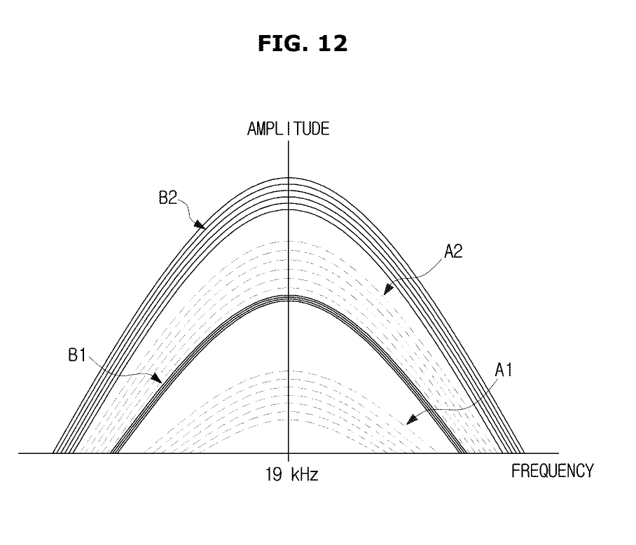

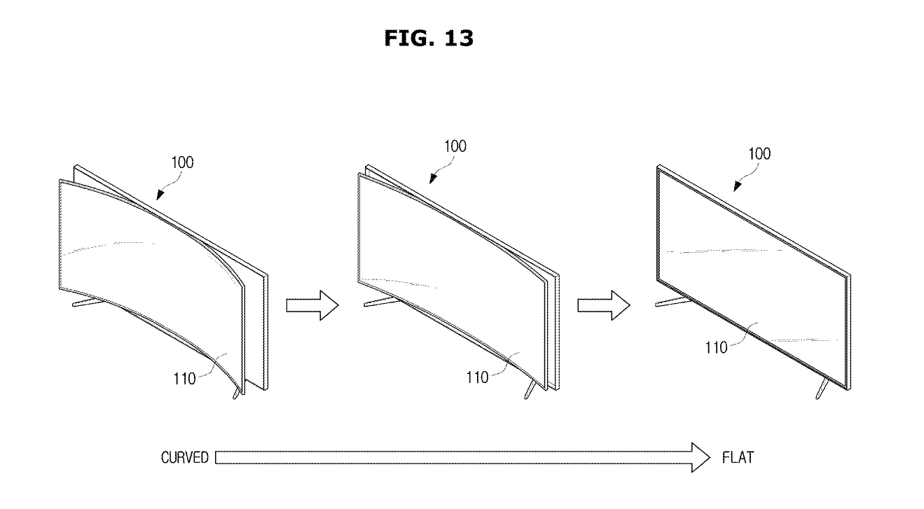

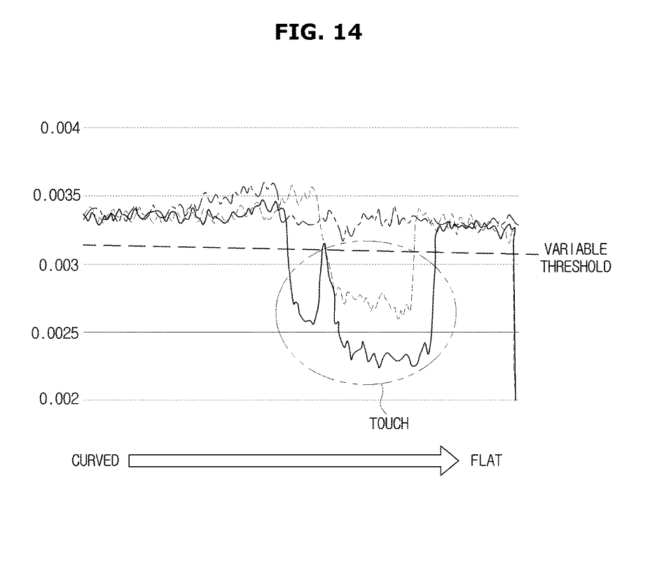

FIG. 12 is a drawing illustrating spectra respectively obtained in the flat state and the curved state of the display panel, FIG. 13 is a drawing illustrating a state of change of the display panel during the unbending operation, and FIG. 14 is a graph for explaining an operation of analyzing an acoustic wave signal based on a variable threshold value. FIG. 12 is a graph showing the amplitude in the frequency domain, and FIG. 14 is a graph showing the amplitude of the acoustic signal in which signal processing is performed in the time domain.

When the display panel 110 is in the flat state, the amplitude of the acoustic wave signal is measured to be smaller than that in the curved state due to the influence of the display panel 110 and other structures. That is, even when the hand is not in contact, a smaller amplitude is measured in the flat state.

Therefore, as shown in FIG. 12, a signal A2 measured when the hand is not in contact in the flat state is measured to be smaller in amplitude than a measured signal B2 when the hand is not in contact in the curved state.

Further, a signal A1 measured when the hand is in the flat state is measured to be smaller in amplitude than a signal B1 measured when the hand is in the curved state.

Accordingly, the controller 120 determines a threshold value of whether or not the hand is in contact in the flat state (a threshold value that is a boundary between A1 and A2), and a threshold value of whether or not the hand is in contact in the curved state (a threshold value that is a boundary between B1 and B2), is set to be different from each other.

On the other hand, as shown in FIG. 13, the unbending operation of the display panel 110 is continuously switched from the curved state to the flat state. That is, intermediate states of various states exist having different curvatures between the curved state and the flat state. Because the degree of the influence of the structures on the wave, that is, the degree of attenuation of the waves, differs for each intermediate state, the signal measured in the curved state and the flat state, and the signal measured in the states in the intermediate state, may appear differently.

Therefore, as shown in FIG. 14, the controller 120 can set a different threshold value, that is, a variable threshold value for each process of configuring the unbending operation, and the controller 120 can determine applying different threshold values corresponding to the curved state→the intermediate states of various states→the flat state, respectively when processing the unbending operation. In other words, the controller 120 can variably set and apply the threshold value corresponding to the curvature of the display panel 110 continuously changing during the unbending operation. As the curvature of the display panel decreases, the threshold value can be set smaller.

In addition, the size of the display panel 110 may also affect the attenuation of the wave. The greater the size of the display panel 110, the greater the degree of influence on the attenuation of the wave. Therefore, the controller 120 can set the threshold value to be smaller as the size of the display panel 110 increases.

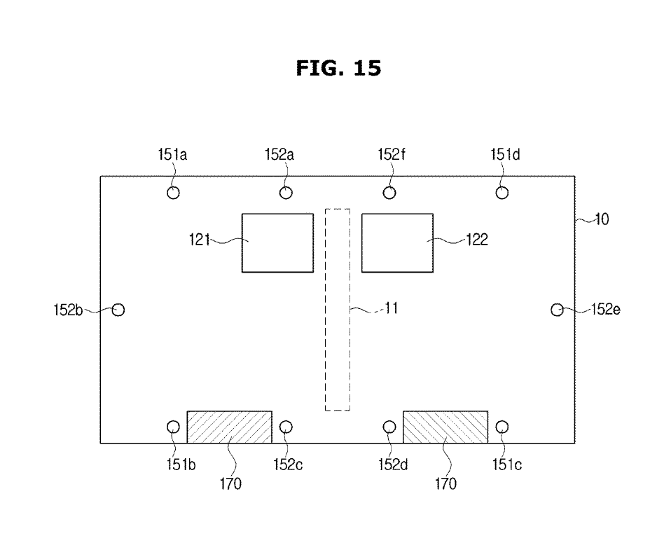

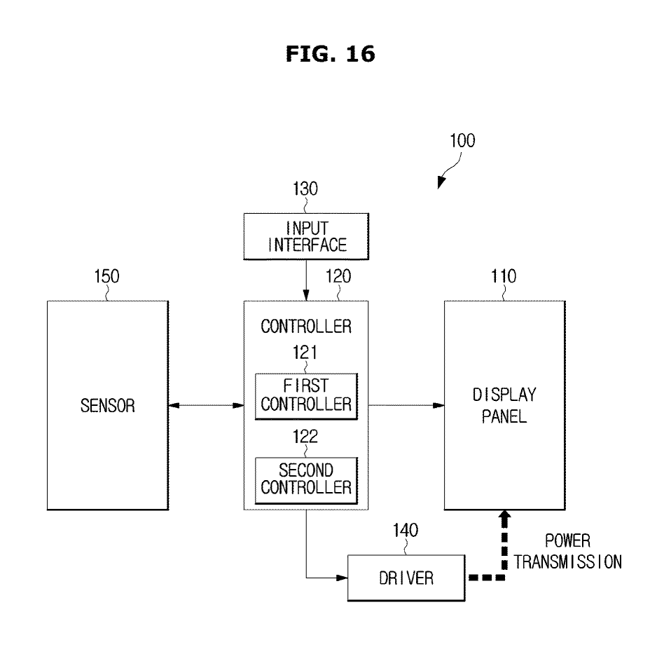

FIG. 15 and FIG. 16 are drawings illustrating an example of the arrangement of the control unit in the display device in accordance with one exemplary embodiment of the present disclosure.

Referring to FIG. 15, on the rear surface of the frame 10, a controller 121, 122 and a speaker 170 may be provided. Also, as described above, the plurality of transmitters 151a, 151b, 151c, and 151d and the plurality of receivers 152a, 152b, 152c, 152d, 152e, and 152f may be provided. Referring to FIGS. 15 and 16, the first controller 121 and the second controller 122, which are physically separated so that the analog sound signal can be efficiently transmitted, are transmitted to the frame 10 respectively, on the left and right sides of the center portion. For example, the first controller 121 and the second controller 122 may be implemented as a Micro Controller Unit MCU in which components such as a processor and a memory are integrated.

In this case, the first controller 121 may analyze the acoustic wave signals transmitted from the first receiver 152a, the second receiver 152b, and the third receiver 152c, and the second controller 122 may analyze the acoustic wave signals transmitted from the fourth receiver 152d, the fifth receiver 152e, and the sixth receiver 152f.

Hereinafter, a method of controlling a display device according to an exemplary embodiment will be described. The display device 100 according to an exemplary embodiment may be applied to a method of controlling a display device according to an exemplary embodiment. Therefore, it is needless to say that the above description with reference to FIGS. 1 to 16 can be applied to a control method of a display device according to an exemplary embodiment, even if not mentioned in the following exemplary embodiments.

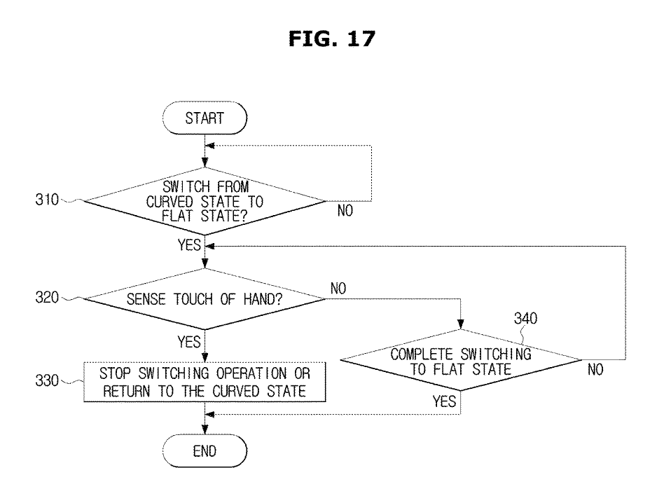

FIG. 17 is a flowchart illustrating a method of controlling a display device in accordance with one exemplary embodiment of the present disclosure.

Referring to FIG. 17, it is determined whether the display panel 110 is being switched from the curved state to the flat state (at operation 310). The controller 120 may determine whether the unbending command is input through the input interface 130 based on whether or not the unbending command is input, or may determine based on whether or not a power off command has been input to the display device 100. Alternatively, it is possible to determine whether or not the unbending operation is being performed based on a signal output from a sensor provided in the motor of the driver 160 or a sensor capable of detecting the position of the display panel 110.

If the display panel is switched from the curved state to the flat state (Yes in operation 310), it senses whether the hand has touched the frame 10, (at operation 320). In this example, although the hand is taken as an example, it is needless to say that the touch of another object other than the hand can be detected.

If a touch of a hand is detected (at operation 320), the controller 120 stops the switching operation or returns to the curved state (at operation 330). That is, if the touch of the hand is detected even before the hand-pinching phenomenon occurs between the display panel 110 and the frame 10, the unbending operation is stopped or the bending operation is performed to return to the curved state to prevent a hand-pinch phenomenon in advance.

If the touch of the hand is not detected (No in operation 320) and the switching to the flat state is not completed (No in operation 340), it is possible to continue judging whether or not the hand touches. That is, it is possible to determine whether or not the hand is in contact until the switching to the flat state is completed.

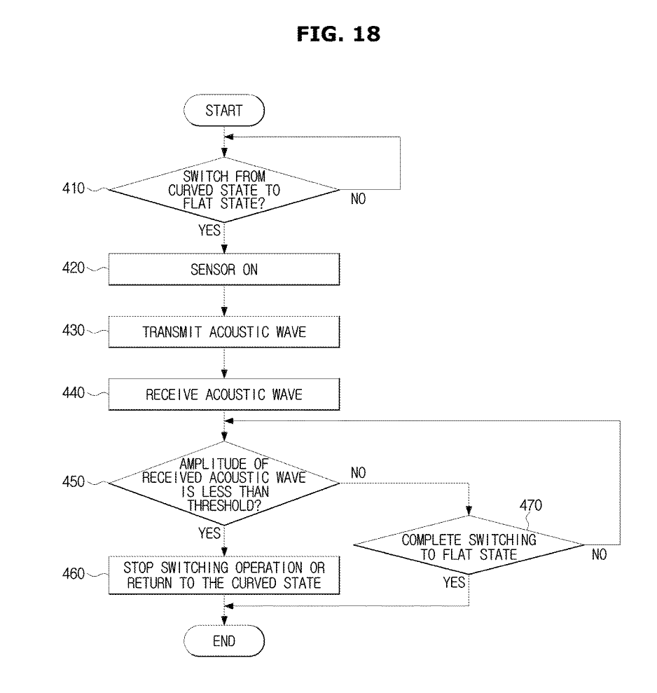

FIG. 18 is a flowchart illustrating a step of detecting a touch of a hand in a method of controlling a display device specifically in accordance with one exemplary embodiment of the present disclosure.

Referring to FIG. 18, If the display panel 110 is being switched from the curved state to the flat state (YES in operation 410), the sensor 150 is turned on (at operation 420). As another example, it is also possible that the sensor 150 is in the normally ON state.

The transmitter 151 transmits the acoustic wave (at operation 430), and the receiver receives the acoustic wave (at operation 440). When the transmitter 151 is mounted on the frame 10 to generate sound waves, the generated sound waves propagate along the surface of the frame 10. The receiver 152 can be mounted on the frame 10 away from the transmitter 151 and receives acoustic waves propagated along the surface of the frame 10. The description of the number and arrangement of the transmitter 151 and the receiver 152 is the same as the description of FIG. 8 to FIG. 10 described above.

The controller 120 determines whether the amplitude of the received acoustic wave signal is less than a threshold value (at operation 450). The controller 120 may store the change pattern of the acoustic wave signal in advance. Specifically, comparing the received acoustic wave signal pattern between when a hand touches and when the hand does not touch, a threshold value may be set as a criterion for judging whether to make a determination of touch can be set in advance.

The threshold value may be set by experiment, simulation, and the like, and it is also possible that the display device 100 is provided with a calibration mode so that the threshold value is reset by the user or the repairman even after the manufacturing is completed.

The controller 120 can set a different threshold value, that is, a variable threshold value for each process of configuring the unbending operation, and the controller 120 can determine applying different threshold value corresponding to the curved state→the intermediate states of various states→the flat state, respectively when processing the unbending operation.

If the amplitude of the acoustic wave signal is less than the threshold value (YES in operation 450), the controller 120 may determine that the touch of the hand is sensed and perform the bending operation to stop the switching operation or to return to the curved state (at operation 460).

If the amplitude of the received acoustic wave signal is not less than the threshold value (No in operation 450), and the switching to the flat state has not been completed (No in operation 470), it can be continuously judged whether the amplitude of the acoustic wave signal is below the threshold value. That is, it is possible to determine whether or not the hand is in contact until the switching to the flat state is completed.

According to the display device and the control method thereof, when the unbending operation of the display panel is performed, the touch of the user's hands or other objects is detected, and when the contact is detected, the unbending operation is stopped or the bending operation is performed again to prevent an object from being caught between the display panel and the frame. This can prevent the risk of an accident or breakage of the device.

Also, by applying the transmitting and receiving acoustic waves to detect the contact of an object, it is possible to detect the contact without applying a large physical pressure, and it is possible to cover almost the whole area without a blind area even if it is not arranged densely as compared with other sensors, and the cost can be reduced. Further, since the display device does not protrude to the outside, the appearance of the display device is not damaged.

Meanwhile, the disclosed exemplary embodiments may be embodied in the form of a recording medium storing instructions executable by a computer. The instructions may be stored in the form of program code and, when executed by a processor, may generate a program module to perform the operations of the disclosed exemplary embodiments. The recording medium may be embodied as a computer-readable recording medium.

The computer-readable recording medium includes all kinds of recording media in which instructions which can be decoded by a computer are stored. For example, there may be a ROM (Read Only Memory), a RAM (Random Access Memory), a magnetic tape, a magnetic disk, a flash memory, an optical data storage device and the like.

The exemplary embodiments disclosed with reference to the accompanying drawings have been described above.

It will be understood by those skilled in the art that the present disclosure may be practiced in other forms than the disclosed exemplary embodiments without departing from the spirit or essential characteristics of the present disclosure. The disclosed exemplary embodiments are illustrative and should not be interpreted with limitation.

### REFERENCE NUMERALS

100: DISPLAY DEVICE
110: DISPLAY PANEL
120: CONTROLLER
130: INPUT INTERFACE
150: SENSOR
140: DRIVER
160: SPEAKER
151: TRANSMITTER
152: RECEIVER

What is claimed is:

1. A display device comprising:
a display panel having a variable curvature, the variable curvature being configured to switch between a curved state and a flat state;
a frame configured to fix a portion of the display panel;
a sensor mounted on the frame, the sensor being configured to transmit and receive acoustic waves; and
a controller configured to determine whether an object is in contact with the frame based on a signal associated with the acoustic waves,
wherein, while the variable curvature is switching from the curved state to the flat state, the switching is stopped in response to a determination that the object is in contact with the frame.

2. The display device of claim 1, wherein the controller is further configured to determine that the object is in contact with the frame when an amplitude of the signal associated with the acoustic waves is less than a predetermined threshold value.

3. The display device of claim 2, wherein the controller is further configured to set the predetermined threshold value based on the variable curvature of the display panel.

4. The display device of claim 2, wherein the controller is further configured to decrease the predetermined threshold value as the variable curvature of the display panel decreases.

5. The display device of claim 1, wherein the sensor comprises:
a plurality of transmitters configured to transmit the acoustic waves; and
a plurality of receivers configured to receive the acoustic waves propagated through a surface of the frame.

6. The display device of claim 5, wherein the plurality of transmitters are further configured to sequentially transmit the acoustic waves.

7. The display device of claim 6, wherein the plurality of transmitters are further configured to transmit the acoustic waves in a more adjacent order as a plurality of distances between the plurality of transmitters increase.

8. The display device of claim 7, wherein the controller is further configured to determine whether the object is in contact with the frame based on a predetermined threshold value, and
wherein the controller is further configured to set the predetermined threshold value based on a distance between the plurality of transmitters and the plurality of receivers.

9. The display device of claim 5, wherein at least one of the plurality of receivers is mounted in an area adjacent to the fixed portion of the display panel.

10. The display device of claim 1, wherein the sensor is activated when the switching begins.

11. The display device of claim 1, wherein the controller is further configured to stop the switching and to return the display panel to the curved state when it is determined that the object is in contact with the frame during the switching of the display panel from the curved state to the flat state.

12. The display device of claim 2, wherein the controller is further configured to set the predetermined threshold value based on a size of the display panel.

13. A control method of a display device with a display panel with a variable curvature, the display device including a frame, the method comprising:
transmitting acoustic waves using a transmitter mounted on the frame;
receiving the acoustic waves using a receiver mounted on the frame;
determining whether an object is in contact with the frame based on a signal associated with the acoustic waves received using the receiver; and
while the variable curvature of the display panel is switching from a curved state to a flat state, stopping the switching in response to a determination that the object is in contact with the frame.

14. The method of claim 13, further comprising:
determining that the object is in contact with the frame when an amplitude of the signal associated with the acoustic waves is less than a predetermined threshold value.

15. The method of claim 14, wherein
the predetermined threshold value is set based on the variable curvature of the display panel.

16. The method of claim 14, wherein
the predetermined threshold value is decreased when the variable curvature of the display panel decreases.

17. The method of claim 15, wherein
the transmitter comprises a plurality of transmitters, and the receiver comprises a plurality of receivers.

18. The method of claim 17, wherein the
transmitting of the acoustic waves comprises transmitting the acoustic waves sequentially from the plurality of transmitters.

19. The method of claim 18, wherein the transmitting of the acoustic waves comprises transmitting the acoustic waves in a more adjacent order as a plurality of distances between the plurality of transmitters increase.

20. The method of claim 19, wherein the determining of whether the object is in contact with the frame comprises setting the predetermined threshold value based on a distance between the plurality of the transmitters and the plurality of the receivers.
